(19) United States
(12) Patent Application Publication
(10) Pub. No.: US 2005/0205567 A1
(43) Pub. Date: Sep. 22, 2005

(54) Decorative strip for kitchen appliances

(76) Inventor: Guanwoo Yoon, Marmaroneck, NY (US)

Correspondence Address: LAW OFFICE OF RICHARD B. KLAR, 28 East Old Country Road, Hicksville, NY, 11801, US

(21) Appl. No.: 10/803,579

(22) Filed: Mar. 18, 2004

(51) Int. Cl. H05B 6/64

(52) U.S. Cl. 219/756

(57) ABSTRACT

A decorative system for a kitchen appliance, such as a microwave oven is provided. The decorative system includes a decorative element and bonding means. The decorative element is bonded to an exterior surface of the kitchen appliance via the bonding means and the decorative element is in the form to provide the kitchen appliance with a look which matches a decor of a kitchen in which the kitchen appliance is located. In addition, the decorative element is in the form to make the appliance easier to clean and also improve the insulation of the kitchen appliance relative to conventional kitchen appliances.

### BACKGROUND OF THE INVENTION

1. Field of the Invention

The present invention relates to decorative strips for kitchen appliances. In particular, the present invention relates to a decorative ceramic strip adhesively applied to the frame or trim of a kitchen appliance such as a microwave oven.

2. The Prior Art

Certain decorative pieces are known in the prior art. For instance, 2002/0050107 A1 relates in relevant part to a trim component system, wherein each trim component includes at least one tile adhered to a backing member. The tile may be natural stone, synthetic stone or ceramic material. In one embodiment, three trim components are present as a fireplace surround. U.S. Pat. No. 5,078,815 relates in relevant part to a method of making a decorative, transparent laminate comprised of a thin layer of stone bonded by an adhesive to a transparent, rigid substrate material. U.S. Pat. No. 5,004,512 relates in relevant part to a method of making a stone veneer panel including finishing one face of a slab of stone material; placing the slab finished face down on a support plate; machining the unfinished face to obtain a predetermined thickness of the slab; and bonding a backing sheet to the unfinished face of the stone slab to produce a composite stone veneer panel. Moreover, U.S. Pat. No. 4,664,955 relates in relevant part a composite laminate for use in the paneling of walls, ceilings and other surfaces such as furniture and the like comprises a polymeric sheet-like core having a pair of surfaces to which are bonded a metal foil so as to form a sandwich-type structure and wherein a lamina of natural facing stone is uniformly bonded to at least one of the pair of metal foils.

Finally, U.S. Pat. No. 3,950,795 relates in relevant part to a decorative cover in the form of decorative material such a textile for the exterior side of a bathtub. The back side of the cover is applied to a plastic sheet carrying adhesive on each side whereby one side of the sheet is adhesively secured to the back side of the cover and the other side of the sheet may be pressed against the outer wall or side of the bathtub to be adhesively secured thereto.

However, the prior art does not solve the problem in which kitchen appliances do not match or actually clash with the decor of a kitchen environment. Thus, there is a strong need in the art for a decorative system for a kitchen appliance comprising decorative elements such as a ceramic element or strip which may be affixed to a chosen exterior surface of a kitchen appliance in order to match the look of kitchen appliance with the decor of the kitchen itself and/or with the plates, dishes, cups, etc. in the kitchen.

### SUMMARY OF THE INVENTION

It is therefore a principle object of the invention to provide decorative elements to be affixed upon a kitchen appliance so as to match the look of the kitchen appliance with the decor of the kitchen itself and/or with the plates, dishes, cups in the kitchen.

It is another object of the present invention to replace the conventional metallic decorum of a kitchen appliance such as a microwave oven with ceramic decorative strips in order to match this appliance to other parts of the kitchen.

It is another object of the present invention to provide a kitchen appliance with decorative strips which are adhesively bonded to the appliance.

It is yet another object of the present invention to provide a kitchen appliance with ceramic decorative strips in order to give the appliance more of a retro feeling.

It is yet another object of the present invention to provide a kitchen appliance with decorative ceramic strips to make the surface of the appliance easier to clean relative to conventional kitchen appliances.

It is a further object of the present invention to provide improved insulation to a kitchen appliance relative to conventional kitchen appliances, through use of ceramic decorative strips affixed thereon.

In accordance with the present invention, a decorative system for a kitchen appliance, such as a microwave oven is provided. The decorative system includes a decorative element and bonding means. The decorative element is bonded to an exterior surface of the kitchen appliance via the bonding means and the decorative element is of the form to provide the kitchen appliance with a look which matches a decor of a kitchen in which the kitchen appliance is located. In addition, the decorative element is of the form to make the appliance easier to clean and also improve the insulation of the kitchen appliance relative to conventional kitchen appliances.

The expression “conventional” kitchen appliances as used herein refers to kitchen appliances without the decorative or ceramic elements of the present invention affixed thereon.

### BRIEF DESCRIPTION OF THE DRAWINGS

FIG. 1 is a perspective view of a conventional microwave oven with metal decor;

FIG. 2 is a perspective view of a microwave oven with the ceramic decor of the present invention;

FIG. 3 is a perspective view of a microwave oven with ceramic pattern decor of the present invention;

FIG. 4 is a cross-sectional view of the microwave oven/ceramic strip attachment of the present invention in FIG. 2 in the direction of arrows 4-4;

FIG. 5 is a fragmentary view of the ceramic strip, adhesive tape and microwave oven surface of the present invention;

FIG. 6 is a cross-sectional view of the microwave oven/ceramic strip attachment of the present invention in FIG. 2 in the direction of arrows 6-6;

FIG. 7 is a cross-sectional view of the microwave oven/ceramic strip attachment of the present invention in FIG. 2 in the direction of arrows 7-7; and

FIG. 8 is a cross-sectional view of the microwave oven/ceramic strip attachment of the present invention in FIG. 2 in the direction of arrow 8.

### DETAILED DESCRIPTION OF PREFERRED EMBODIMENTS

The present invention relates to a decorative system for a kitchen appliance. Specifically, the decorative system of the present invention provides a kitchen appliance with a look which matches a decor of the kitchen in which the appliance is located, makes the appliance easier to clean, and improves the insulation of the appliance relative to conventional kitchen appliances. However, it is noted that the decorative system of the present invention is not limited to any particular kitchen appliance but rather also encompasses any such kitchen appliance which would work in the same manner as described herein.

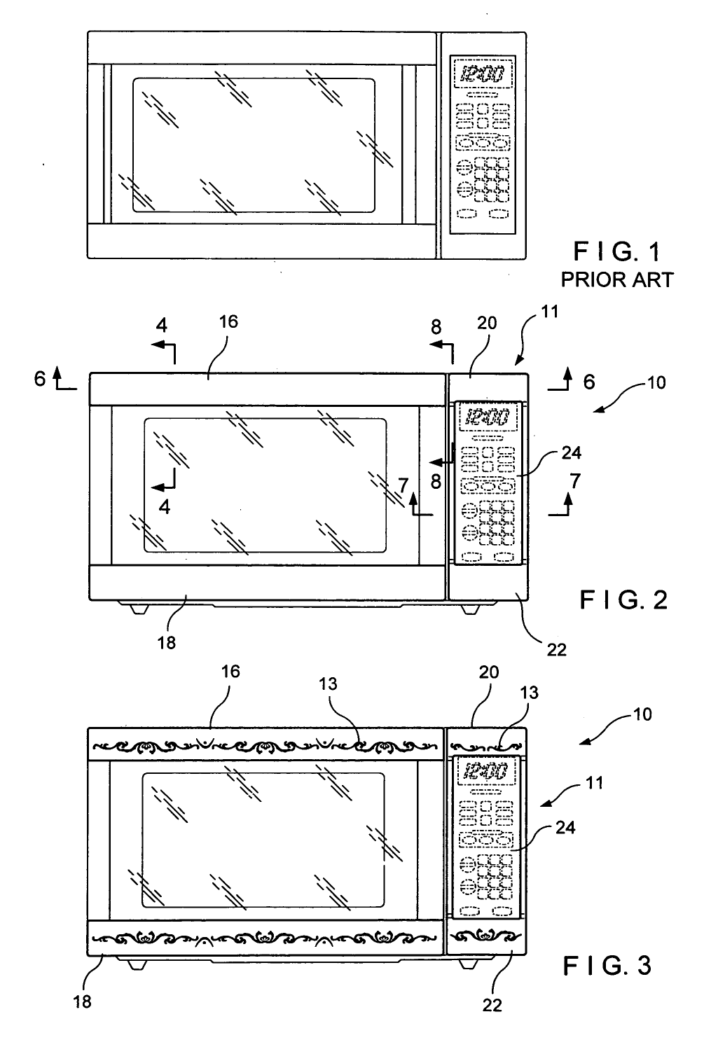

Referring to the figures, FIG. 1 depicts a conventional prior art microwave oven having only a metallic decor without the decorative system of the present invention. Turning to FIGS. 2-8, the decorative system of the present invention for a kitchen appliance is referred to generally as reference numeral 10 in these drawings.

The decorative system 10 of the present invention for a kitchen appliance includes at least one decorative element 12. In a preferred embodiment of the present invention as illustrated in FIGS. 2-8, the kitchen appliance is a microwave oven 11 and the decorative element 12 is preferably a ceramic element such as a ceramic strip. The ceramic elements or strips 12 only represent a preferred embodiment of the present invention and thus other materials which accomplish the same purposes are considered to be within the scope of the present invention. As shown in FIG. 3, the ceramic element or strip 12 may also contain decorative patterns 13 thereon to match the decor of the microwave to the kitchen decor or environment. The decorative pattern 13 may be placed onto the cermanic elements or strips 12 using painting techinques or any other technique known in the art for designing ceramic pieces which would also be in conformance with the purposes of the present invention described herein.

Moreover, as illustrated in FIGS. 2-3, it is preferable to have a plurality of variably sized and shaped ceramic elements or strips 12 to be affixed onto different areas of the exterior surface of the microwave 11 to provide a look or decor for the microwave oven 11 which matches the decor of the kitchen decor itself and/or matches the plates, dishes, cups, etc. in the kitchen. For example, as depicted in FIGS. 2 and 3, the ceramic elements or strips 12 are designed so as to fit on the top face 16 and bottom face 18 of the frontal exterior of the microwave oven 11. In addition, ceramic elements or strips 12 are designed to be affixed onto the panel above 20 and onto the panel below 22 the keypad 24 of the microwave oven 11. In addition, a ceramic element or strip 12 could also be designed for being affixed over the entire keypad 24 of the microwave oven 11 and contain openings therein to allow the user of the microwave 11 to use the keypad 24 through the openings in ceramic element or strip 12. The above serve only as examples of preferred places in which the ceramic elements or strips 12 may be placed on the microwave oven 11 kitchen appliance and are in no way meant to limit the scope of the present invention. Lastly, the shapes and sizes of the ceramic elements or strips 12 are to be of the proper dimensions such as the proper length, width, height and thickness so that they are able to be affixed onto the exterior surfaces 26 of a chosen kitchen appliance, e.g. a microwave oven 11.

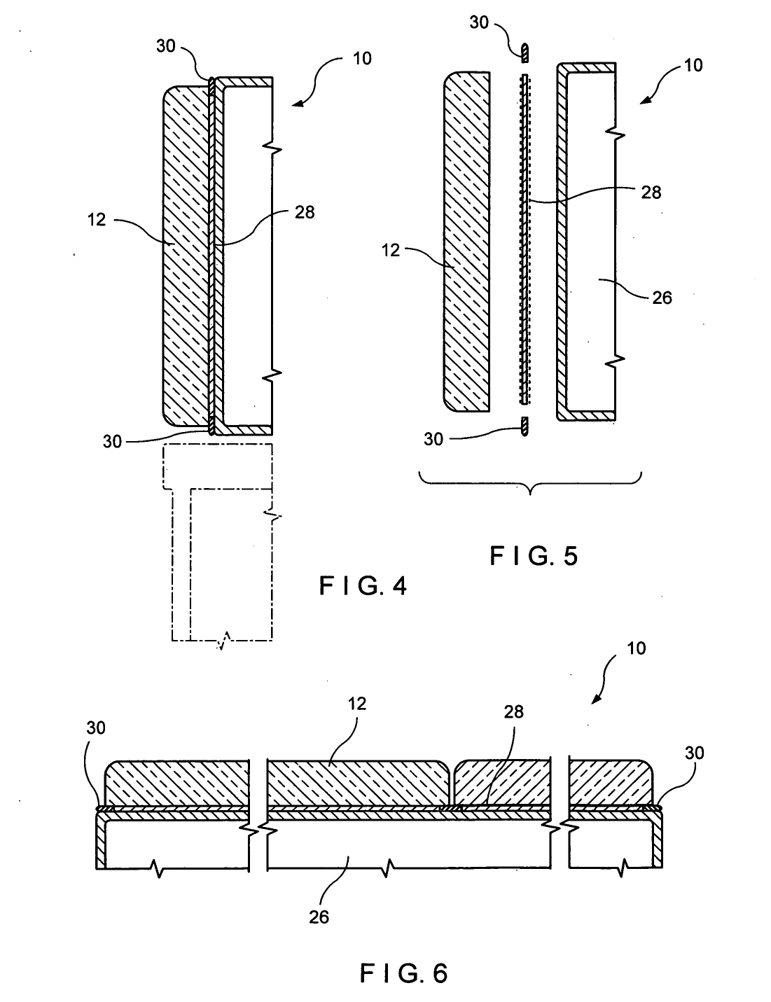

Further, as illustrated in FIGS. 4-8, (especially in FIG. 5), the ceramic element or strip 12 is affixed to the exterior surface of the microwave 11 via a bonding or adhesive means, such as double sided adhesive sticky tape 28. As illustrated in FIGS. 4-8, when the decorative system 10 is assembled, one side of the double sided tape 28 is located on ceramic element or strip 12 and the other side of the double sided tape 28 is located on the chosen exterior surface 26 of the microwave oven 11 for connecting the ceramic element or strip 12 with the chosen exterior surface 26 of the microwave oven 11. It is noted that the present invention is not limited to double sided adhesive sticky tape 28 and that other bonding means which are known in the art for accomplishing the purposes of the present invention are also contemplated to be within its scope.

The ceramic elements or strips 12 may be produced by any conventional methods known in the art for producing ceramic elements or strips 12 which would function for the purposes of the present invention described herein. The ceramic elements 12 should be so shaped and sized as to be appropriate for use with the kitchen appliances they are to be affixed onto.

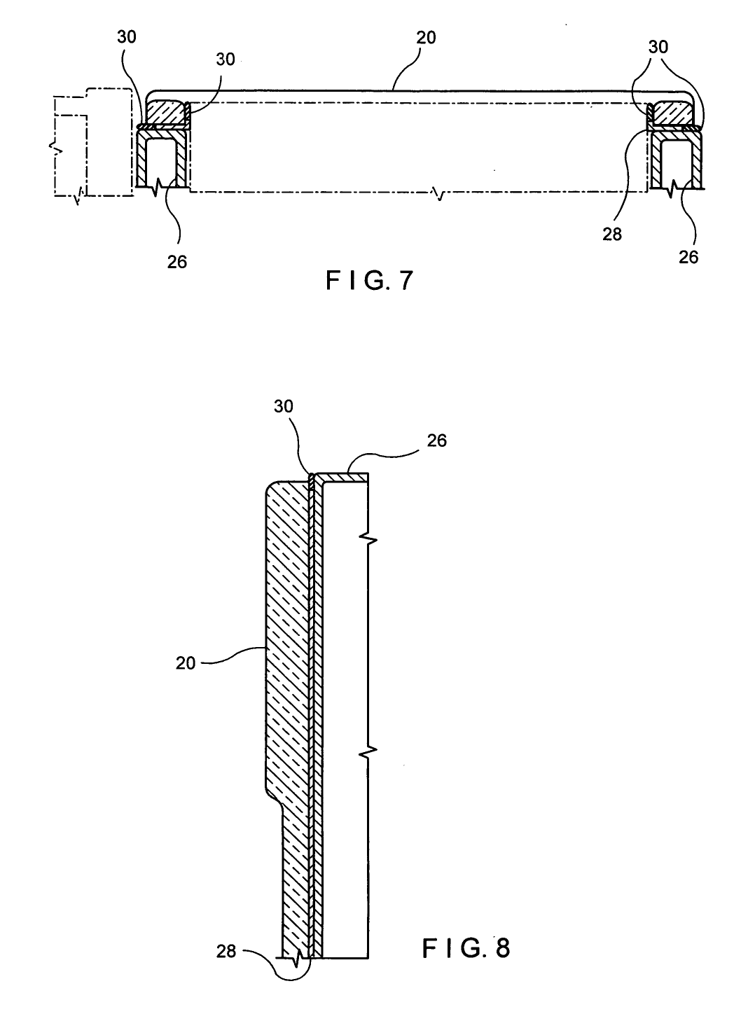

It is also preferred, as illustrated in FIGS. 5 and 7, to have protective elements or rims 30 located along the outer edges of the ceramic elements or strips 12 to protect the ceramic elements or strips 12. These protective rims 30 protect the ceramic elements or strips 12 by wrapping around the edges of the ceramic elements 12 to provide cushioning for these elements 12. It is preferred that these protective rims 30 are composed of rubber. In using the decorative system of the presently claimed invention illustrated in FIGS. 2 and 3, a user would first select at least one ceramic element 12 to affix onto a chosen exterior surface 26 of the microwave oven 11. The user would then apply bonding means to the chosen ceramic element 12 and/or to the chosen exterior surface 26 of the microwave oven 11 in order to connect the ceramic element or strip 12 with the chosen exterior surface 26. In the case of using double sided adhesive sticky tape 28 as the bonding means, as illustrated in FIGS. 4-8, the user would place one sticky end of the double sided adhesive sticky tape 28 on either the bottom side of the ceramic element or strip 12 or alternatively on the chosen exterior surface 26 of the microwave 11. This would leave one sticky side free to connect with either the chosen exterior surface 26 of the microwave oven 11 or the bottom of the ceramic element or strip 12, depending on where the sticky end of the adhesion tape 28 was placed. Next, the user would then affix the free sticky end of double sided adhesive tape 28 which is attached to either the bottom of ceramic strip 12 or the exterior surface of the microwave 11, so as to connect the ceramic strip 12 with the exterior surface 26 of the microwave 11. Finally, if desired, the user would repeat the above steps with another ceramic element or strip 12.

The particulars embodiment described above is not meant to be exclusive. Many other variations of the present invention would be obvious to those skilled in the art, and are contemplated to be within the scope of the appended claims.

1. A decorative system for a kitchen appliance comprising:
a decorative element, said decorative element is attached to an exterior surface of said kitchen appliance; and
whereby said decorative element is in the form to provide the kitchen appliance with a look which matches a decor of a kitchen in which the kitchen appliance is located, make the appliance easier to clean, and improve the insulation of the appliance relative to conventional kitchen appliances.

2. The decorative system of claim 1, wherein said kitchen appliance is a microwave oven.

3. The decorative system of claim 1, wherein said decorative element is attached to said exterior surface of said kitchen appliance by bonding means.

4. The decorative system of claim 1, wherein said bonding means is a doubled sided adhesive sticky tape.

5. The decorative system of claim 1, wherein said decorative element is a ceramic element.

6. The decorative system of claim 4, wherein said ceramic element is a ceramic strip.

7. The decorative system of claim 1, wherein said decorative element has a decorative pattern located thereon.

8. The decorative system of claim 1, further comprising a plurality of variably sized and shaped decorative elements to be affixed onto different areas of said exterior surface of said kitchen appliance.

9. The decorative system of claim 1, further comprising a pair of protective members which wrap along edges of the at least decorative element to protect the decorative element

10. A decorative ceramic system for a microwave oven comprising:
a plurality of decorative ceramic elements;
bonding means, said plurality of decorative ceramic elements are bonded to exterior surfaces on said microwave oven via said bonding means; and
whereby said plurality of decorative ceramic elements is in the form to provide the microwave oven with a look which matches a decor of a kitchen in which the microwave oven is located, make the microwave oven easier to clean, and improve the insulation of the microwave oven relative to conventional microwave ovens.

11. The decorative ceramic system of claim 10, wherein at least one of said plurality of ceramic elements has a decorative pattern located thereon.

12. The decorative ceramic system of claim 10, wherein said plurality of decorative ceramic elements are decorative ceramic strips.

13. The decorative system of claim 10, wherein said bonding means comprises double sided adhesive tape.

14. A method for providing a decor to a kitchen appliance which matches the decor of a kitchen in which the kitchen appliance is located, comprising the steps of:
selecting at least one decorative element to be affixed onto a chosen exterior surface of the kitchen appliance;
applying bonding means to said at least one decorative element and/or to said chosen exterior surface of said kitchen appliance;
affixing said decorative element to said chosen exterior surface of said kitchen appliance via said bonding means; and
repeating the above steps, if desired, with another decorative element.

15. The method of claim 14, wherein said kitchen appliance is a microwave oven.

16. The method of claim 14, wherein said bonding means comprises double sided adhesive sticky tape.

17. The method of claim 14, wherein said decorative element is a ceramic element.

18. The method of claim 17, wherein said ceramic element is a ceramic strip.

19. The method of claim 14, wherein said decorative element has a decorative pattern located thereon.

20. The method of claim 14, further comprising adding a plurality of variably sized and shaped decorative elements to be affixed onto different areas of said exterior surface of said kitchen appliance.
